(19) United States
(12) Patent Application Publication
(10) Pub. No.: US 2011/0123861 A1
(43) Pub. Date: May 26, 2011

(54) HIGH PERFORMANCE CURRENT COLLECTOR

(75) Inventors: NAE-LIH WU, TAIPEI 10617 (TW); HSIEN-CHANG WU, TAIPEI 10617 (TW)

(73) Assignee: NATIONAL TAIWAN UNIVERSITY, TAIPEI (TW)

(21) Appl. No.: 12/917,411

(22) Filed: Nov. 1, 2010

(30) Foreign Application Priority Data
Nov. 25, 2009 (TW) 098140225

(51) Int. Cl. H01M 4/02; B05D 5/12

(52) U.S. Cl. 429/209; 427/122

(57) ABSTRACT

A current collector is provided. The current collector includes a current-conductive element; and a carbonaceous mixture thin film formed on the current-conductive element.

### CROSS-REFERENCE TO RELATED APPLICATION AND CLAIM OF PRIORITY

This application claims the benefit of Taiwan Patent Application No. 098140225, filed on Nov. 25, 2009, in the Taiwan Patent and Trademark Office, the disclosures of which are incorporated herein in their entirety by reference.

### FIELD OF THE INVENTION

The present invention relates to a current collector, and more particularly to a high performance current collector.

### BACKGROUND OF THE INVENTION

Traditionally, in the manufacture of the energy storage device for the electrochemical element, most electrodes use current collector for current transmission. There are many materials for the current collector in the market, e.g. aluminum, copper, titanium foil, etc. The conventional way of manufacturing the electrode is to add a binder to the slurry of the active substance, cover the current collector with the slurry of the active substance, and then dry the slurry of the active substance to form an active layer. The metal surface of the current collector is easy to be oxidized, which is hydrophilic, but the active layer includes organic binder, which is lipophilic. In the process of manufacturing the electrode, the attachment between the active layer and the current collector will deteriorate due to different properties therebetween. Besides, during charging and discharging, an extremely large interface impedance will be generated between interfaces, which causes loss of energy. Moreover, the active layer will easily peel off after use over a period of time, which reduces the life of the battery.

Currently, the technology to solve the above-mentioned problems is to cover the current collector with a carbon layer through a chemical way. This can remove the oxidation layer on the surface of the current collector, thereby increasing the electric conductivity. Besides, the carbon layer formed is lipophilic so that it has better affinity with the active layer. In WO 2004/087984 A1, an aluminum board is first covered with a layer of organic substances, and then the chemical vapor deposition is performed. This can decompose the organic substances and increase the content of carbon, thereby forming a carbon layer containing carbon-aluminum alloy.

In order to overcome the drawbacks in the prior art, a current collector of high performance is provided. The particular design in the present invention not only solves the problems described above, but also is easy to implement. Thus, the present invention possesses potential for industrial applications.

### SUMMARY OF THE INVENTION

In accordance with one aspect of the present invention, a current collector of high performance is provided, which increases the electric conductivity and enhances the interfacial bonding between the active layer and the current collector.

In accordance with another aspect of the present invention, a current collector is provided. The current collector includes a current-conductive element; and a carbonaceous mixture thin film formed on the current-conductive element.

According to an embodiment of the present invention, the current-conductive element includes a metal plate.

According to an embodiment of the present invention, the metal plate includes an aluminum foil.

According to an embodiment of the present invention, the carbonaceous mixture thin film includes a carbon-nitrogen thin film.

According to an embodiment of the present invention, the carbon-nitrogen thin film has a molar ratio of nitrogen to carbon in a range of 0.05 to 0.5.

According to an embodiment of the present invention, the carbon-nitrogen thin film has a molar ratio of nitrogen to carbon in a range of 0.1 to 0.2.

According to an embodiment of the present invention, the carbonaceous mixture thin film has a plurality of protrusions thereon.

According to an embodiment of the present invention, each of the protrusions has a length of 0.01 to 0.05 μm.

According to an embodiment of the present invention, the carbonaceous mixture thin film has a thickness of 0.01 to 2.0 μm.

In accordance with a further aspect of the present invention, an electrode is provided. The electrode includes a current collector, including a metal plate; and a carbon-nitrogen thin film formed on the metal plate.

According to an embodiment of the present invention, the carbon-nitrogen thin film has a molar ratio of nitrogen to carbon in a range of 0.05 to 0.5.

According to an embodiment of the present invention, the carbon-nitrogen thin film has a molar ratio of nitrogen to carbon in a range of 0.1 to 0.2.

According to an embodiment of the present invention, the carbon-nitrogen thin film has a thickness of 0.01 to 2.0 μm.

According to an embodiment of the present invention, the carbon-nitrogen thin film has a plurality of protrusions thereon.

According to an embodiment of the present invention, each of the protrusions has a length of 0.01 to 0.05 μm.

According to an embodiment of the present invention, the metal plate includes an aluminum foil.

According to an embodiment of the present invention, the electrode further includes an active layer formed on the carbon-nitrogen thin film.

In accordance with further another aspect of the present invention, a method of manufacturing a current collector is provided. The method includes steps of providing a metal plate; and forming a carbon-nitrogen thin film on the metal plate.

According to an embodiment of the present invention, the method further includes a step of forming the carbon-nitrogen thin film by using a mixed gas of methane with ammonia in a ratio of 4:1 at 500 to 600° C.

The above objects and advantages of the present invention will become more readily apparent to those ordinarily skilled in the art after reviewing the following detailed descriptions and accompanying drawings.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows an electrode including a current collector according to an embodiment of the present invention.

### DETAILED DESCRIPTION

The present invention will now be described more specifically with reference to the following embodiments. It is to be noted that the following descriptions of embodiments of this invention are presented herein for the purposes of illustration and description only; it is not intended to be exhaustive or to be limited to the precise form disclosed.

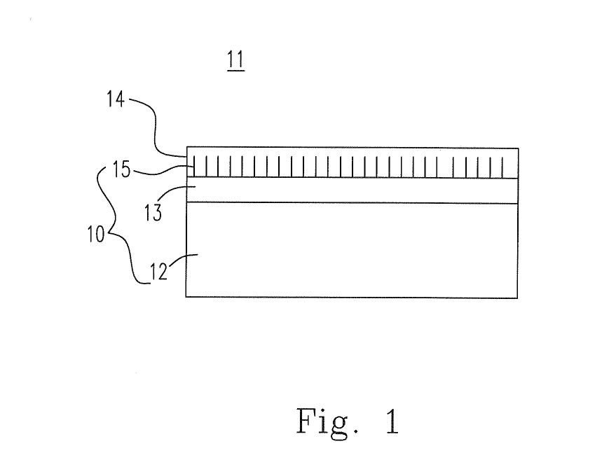

Please refer to FIG. 1, which shows an electrode including a current collector according to an embodiment of the present invention. The electrode 11 includes the current collector 10. The current collector 10 includes a metal plate 12 and a carbon-nitrogen thin film 13. The carbon-nitrogen thin film 13 is formed on the metal plate 12 and has a plurality of protrusions 15. The electrode 11 further includes an active layer 14 formed on the carbon-nitrogen thin film 13. The contact area between the active layer 14 and the carbon-nitrogen thin film 13 is increased and the interfacial bonding therebetween is enhanced through the protrusions 15 of the carbon-nitrogen thin film 13. Besides, the protrusions 15 of the carbon-nitrogen thin film 13 can further form a high electrically conductive route in the active layer 14. This increases the flow rate of the current and reduces the impedance.

The general current collector uses the aluminum foil as the metal electrode. In the present invention, a carbon-nitrogen thin film is formed on the aluminum foil of 100 μm by using a mixed gas of methane (CH₄) with ammonia (NH₃) in a ratio of 4:1 at 500 to 600° C. for 20 hours. Then, an element analysis is performed. From the element analysis, it is known that the content ratio of C:N is 1:0.15. Moreover, it is observed from an electron microscope that the carbon-nitrogen thin film has a plurality of protrusions on its surface, wherein the length of each protrusion is about 0.01 to 0.05 μm and the diameter thereof is 0.001 μm.

In the comparative example, a pure carbon thin film is formed on the aluminum foil of 100 μm by using a gas of pure methane at 500 to 600° C. for 20 hours.

Finally, the above two current collectors are covered with an active layer respectively to form two different electrodes. The active layer is composed of 85% LiFePO₄, 5% graphite slice, 2% carbon black and 8% binder.

In the following, the measurement and comparison of the electrochemical properties for the current collector of the present invention and that of the comparative example respectively are performed. The lithium foil is used as an opposite electrode during the charging and discharging.

Table 1 shows the measurement of the specific capacity at different charging/discharging rates under the room temperature.

TABLE 1

| | Carbon-nitrogen | Pure carbon |
|---|---|---|
| | thin film | thin film (the |
| Composition of the current | (the present | comparative |
| collector | invention) | example) |
| Specific capacity at 1 C | 150 | 131 |
| rate (mAh/g) | | |
| Specific capacity at 3 C rate | 138 | 116 |
| mAh/g | | |
| Specific capacity at 10 C rate | 112 | 88 |
| (mAh/g) | | |

Table 2 shows the measurement of the high-frequency series impedance by an AC impedance tester, wherein the current collector of the present invention has lower impedance than that of the comparative example.

TABLE 2

| | Carbon-nitrogen | Pure carbon |
|---|---|---|
| | thin film | thin film (the |
| Composition of the current | (the present | comparative |
| collector | invention) | example) |
| Series impedance (Ω) | 1.6 | 2.9 |

According to the above comparisons, the current collector of the present invention indeed has a higher specific capacity and lower impedance than those of the conventional current collector using the pure carbon thin film.

Furthermore, there are many ways to form the carbon-nitrogen thin film. For one example, the chemical substance including carbon and that including nitrogen are simultaneously reacted on the metal plate 12 to form the carbon-nitrogen thin film for one time, as described in the embodiment of the present invention. For another example, a carbon thin film is plated on the metal plate 12 first, and then reacted with the chemical substance including nitrogen to be converted into a carbon-nitrogen thin film, as described in the comparative example. The plating can be performed by the vapor deposition, cracking or the plasma reaction technology.

In conclusion, the present invention not only increases the contact area between the active layer and the current collector to enhance the interfacial bonding therebetween, but also creates a high electrically conductive route for the current to reduce the impedance. Therefore, the present invention has the effects of a higher specific capacity and lower impedance, which is better than the prior art. Hence, the present invention effectively solves the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A current collector, comprising:
a current-conductive element; and
a carbonaceous mixture thin film formed on the current-conductive element.

2. A current collector as claimed in claim 1, wherein the current-conductive element comprises a metal plate.

3. A current collector as claimed in claim 2, wherein the metal plate comprises an aluminum foil.

4. A current collector as claimed in claim 1, wherein the carbonaceous mixture thin film includes a carbon-nitrogen thin film.

5. A current collector as claimed in claim 4, wherein the carbon-nitrogen thin film has a molar ratio of nitrogen to carbon in a range of 0.05 to 0.5.

6. A current collector as claimed in claim 4, wherein the carbon-nitrogen thin film has a molar ratio of nitrogen to carbon in a range of 0.1 to 0.2.

7. A current collector as claimed in claim 1, wherein the carbonaceous mixture thin film has a plurality of protrusions thereon.

8. A current collector as claimed in claim 7, wherein each of the protrusions has a length of 0.01 to 0.05 μm.

9. A current collector as claimed in claim 1, wherein the carbonaceous mixture thin film has a thickness of 0.01 to 2.0 μm.

10. An electrode, comprising:
a current collector, comprising:
a metal plate; and
a carbon-nitrogen thin film formed on the metal plate.

11. An electrode as claimed in claim 10, wherein the carbon-nitrogen thin film has a molar ratio of nitrogen to carbon in a range of 0.05 to 0.5.

12. An electrode as claimed in claim 10, wherein the carbon-nitrogen thin film has a molar ratio of nitrogen to carbon in a range of 0.1 to 0.2.

13. An electrode as claimed in claim 10, wherein the carbon-nitrogen thin film has a thickness of 0.01 to 2.0 μm.

14. An electrode as claimed in claim 10, wherein the carbon-nitrogen thin film has a plurality of protrusions thereon.

15. An electrode as claimed in claim 14, wherein each of the protrusions has a length of 0.01 to 0.05 μm.

16. An electrode as claimed in claim 10, wherein the metal plate comprises an aluminum foil.

17. An electrode as claimed in claim 10, further comprising:
an active layer formed on the carbon-nitrogen thin film.

18. A method of manufacturing a current collector, comprising steps of:
providing a metal plate; and
forming a carbon-nitrogen thin film on the metal plate.

19. A method as claimed in claim 18, further comprising a step of forming the carbon-nitrogen thin film by using a mixed gas of methane with ammonia in a ratio of 4:1 at 500 to 600° C.
